(19) United States
(12) Patent Application Publication
(10) Pub. No.: US 2007/0214052 A1
(43) Pub. Date: Sep. 13, 2007

(54) Consumer Driven Telecommunication Integrated System for Hospitality Application

(76) Inventor: Chiuan-liang Kao, North York (CA)

Correspondence Address: FURR LAW FIRM, 2622 DEBOLT ROAD, UTICA, OH, 43080, US

(21) Appl. No.: 11/532,536

(22) Filed: Sep. 17, 2006

Related U.S. Application Data
(60) Provisional application No. 60/767,107, filed on Mar. 3, 2006.

(51) Int. Cl. G06Q 30/00

(52) U.S. Cl. 705/15

(57) ABSTRACT

The invention is an all-in-one and quality assurance control loop system for the process of Restaurant Operation. It has interfaces and expression of restaurant information on a website. This website will include marketing applications for restaurants such as games, auctions, message banners, job portals, event boards, broadcasting systems, fan group forming, chat room, Instant Messenger, and E-Invite. The system would have a Marketing Interface and approach which would include a Restaurant BLOG and My Kitchen/My Kitchen BLOGs for the chefs. The system would have a Cross Reference and an artificial intelligent Smart Suggestions of restaurants for a user. The system would include a calendar tool, event planner, and coupon collections to allow a user to schedule their visit to the restaurant. The system would have customer/Restaurant Interactive communication channels by E-mail, chat room, MMS, SMS, and other such communication methods.

### CROSS-REFERENCES TO RELATED APPLICATIONS (IF ANY)

None

### STATEMENT AS TO RIGHTS TO INVENTIONS MADE UNDER FEDERALLY-SPONSORED RESEARCH AND DEVELOPMENT (IF ANY)

None

### BACKGROUND

1. Field of the Invention

This invention relates generally to restaurant systems and more particularly to the process of interactive system that allows for customer interaction over the internet.

2. Description of Prior Art

With the increasing popularity of the Internet and the global workplace, a User may be able to send electronic mail messages to anyone who is connected to the Internet. The sender of an electronic mail message needs only to know the electronic mail address of the recipient. Thus, Users can and often do receive electronic mail messages from unknown senders. Because of the perceived benefits of advertising via the Internet on the low costs of doing so, many companies are using electronic mail messages as a way to get messages to their clients. These companies acquire and maintain lists of electronic mail addresses for thousands of customers. When a client wants to advertise a product, the promotional company will send an electronic mail message to each electronic mail address in its list.

Many restaurants and food deliveries have websites. Sometimes these websites have information about the restaurant and the food that is served. Sometimes these websites will allow a person to order their food online. There are also some websites that give a critique of the restaurants and foods that the restaurant serves. But there is no website or system in prior art that allows for the ordering of the food, and the rating of the restaurant and food as well as the cooks and chefs from a multiple number of locations and restaurants in a single website.

There is still room for improvement within the art.

### SUMMARY OF THE INVENTION

The object of the present invention is to provide an all-in-one and quality assurance control loop system for the process of Restaurant Operation. It has interfaces and expression of restaurant information on a website. This website will include marketing applications for restaurants such as games, auctions, message banners, job portals, event boards, broadcasting systems, fan group forming, chat room, Instant Messenger, and E-Invite. The system would have a Marketing Interface and approach which would include a Restaurant BLOG and My Kitchen/My Kitchen BLOGs for the chefs. The system would have a Cross Reference and an artificial intelligent Smart Suggestions of restaurants for a user. The system would include a calendar tool, event planner, and coupon collections to allow a user to schedule their visit to the restaurant. The system would have Customer/Restaurant Interactive communication channels by E-mail, chat room, MMS, SMS, and other such communication methods.

The system will use telecommunication technology integration which is the integration of order/reservation and management directory/interface. The system will use a number of various methods to group and invite customers to dine at the participating restaurants using many business marketing campaigns and methods.

The system offers advanced menu and discount management interface. The system will provide consumers' favorites, consumer diet analysis and smart suggestions based on inputted data.

The process is more efficient, effective, and functional than the current art.

### Glossary of Terms

Browser: a software program that runs on a client host and is used to request Web pages and other data from server hosts. This data can be downloaded to the client's disk or displayed on the screen by the browser.
Client host: a computer that requests Web pages from server hosts, and generally communicates through a browser program.
Content provider: a person responsible for providing the information that makes up a collection of Web pages.
Embedded client software programs: software programs that comprise part of a Web site and that get downloaded into, and executed by, the browser.

### Cookies: data blocks that are transmitted to a client browser by a web site.

### Hit: the event of a browser requesting a single Web component.

Host: a computer that is connected to a network such as the Internet. Every host has a hostname (e.g., mypc.mycompany.com) and a numeric IP address (e.g., 123.104.35.12).
HTML (HyperText Markup Language): the language used to author Web Pages. In its raw form, HTML looks like normal text, interspersed with formatting commands. A browser's primary function is to read and render HTML.

### HTTP (HyperText Transfer Protocol): protocol used between a browser and a Web server to exchange Web pages and other data over the Internet.

### HyperText: text annotated with links to other Web pages (e.g., HTML).

### IP (Internet Protocol): the communication protocol governing the Internet.

Server host: a computer on the Internet that hands out Web pages through a Web server program.
URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.
UWU server: in connection with the present invention, a special Web server in charge of distributing statistics describing Web traffic.

### Visit: a series of requests to a fixed Web server by a single person (through a browser), occurring contiguously in time.

Web master: the (typically, technically trained) person in charge of keeping a host server and Web server program running.
Web page: multimedia information on a Web site. A Web page is typically an HTML document comprising other Web components, such as images.
Web server: a software program running on a server host, for handing out Web pages.
Web site: a collection of Web pages residing on one or multiple server hosts and accessible through the same hostname (such as, for example, www.lucent.com).

### BRIEF DESCRIPTION OF THE DRAWINGS

Without restricting the full scope of this invention, the preferred form of this invention is illustrated in the following drawings:

FIG. 1 shows an overview of the accessing of the system;

FIG. 2 shows the four sections of the system;

FIG. 3 is a block diagram of the public area of the system;

FIG. 4 is a block diagram of the customer member area of the system;

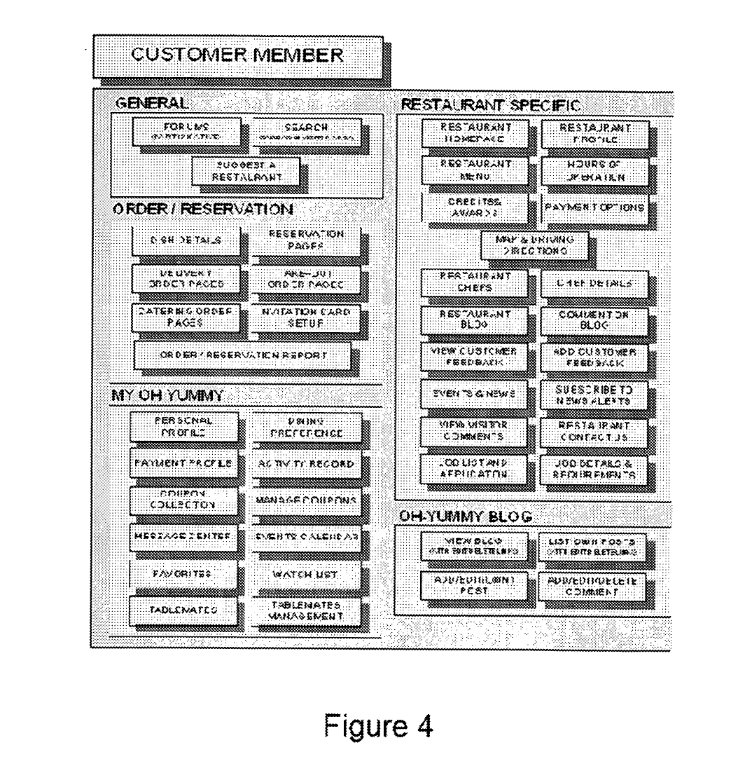

FIG. 5 is a block diagram of the restaurant member area of the system;

FIG. 6 shows the major components of the system; and

FIG. 7 displays some of the website concepts and diagrams.

### DESCRIPTION OF THE PREFERRED EMBODIMENT

Below is the preferred embodiment of the current invention, but it is not the only embodiment of the current invention and should not be read as such.

The System 1 is a computer system and method for an all-in-one and quality assurance control loop system for the process of Restaurant Operation. It has interfaces and expression of restaurant information on a website. This website will include marketing applications for restaurants such as games, auctions, message banners, job portals, event boards, broadcasting systems, fan group forming, chat room, Instant Messenger, and E-Invite. The system would have a Marketing Interface and approach which would include a Restaurant BLOG and My Kitchen/My Kitchen BLOGs for the chefs. The system would have a Cross Reference and an artificial intelligent Smart Suggestions of restaurants for a user. The system would include a calendar tool, event planner, and coupon collections to allow a user to schedule their visit to the restaurant. The system would have customer/Restaurant Interactive communication channels by E-mail, chat room, MMS, SMS, and other such communication methods. The system 1 will allow the Restaurant Members to send messages to the Customers using these communication methods. These messages can be about offers or be advertisements or general messages.

The system 1 will provide a downloadable and installable application that customers can install on their local computer and resided on the Internet Browser as a shortcut. It will be similar to Yahoo Tool Bar or Google Tool Bar. The System Shortcut Bar will provide links and shortcuts to many features in system's website 100 So that user can view Restaurant Promotion News, use the shortcuts or links such as “Most Popular Restaurant, Top Restaurants, Most Popular Dishes, Top Dishes—which updates on regular basis), Search Tools (for restaurant, Blogs, Dishes, Jobs and Chefs), Instant Messenger (to other members and restaurant), short cuts to “My Restaurant Blog”, TableMate Radar shortcut, My Favorite Restaurant shortcut, Games shortcut, Record/Activity Tracking and History shortcut, My Old Goodies Shortcut and the one of the most important shortcuts—the Ordering and Reservation shortcut.

The system 1 will use telecommunication technology integration which is the integration of order/reservation and management directory/interface. The system will use a number of various methods to group and invite customers to dine at the participating restaurants using many business marketing campaigns and methods.

The system offers advanced menu and discount management interface. The system will provide consumer's favorites, consumer diet analysis and smart suggestions based on inputted data.

The current invention will improve restaurant Operation Model. The system will provide planning for: Order Trend & Analysis; Menu Design, Marketing; Targeted Marketing Campaign; order/Delivery with internet based order/delivery System (Long Term and Immediate); Dining: Discount and Various Loyal Programs to Keep Customers; Food Preparation: Customer Request Dining Orders and Requirements; Customer Satisfaction with Customer Feedback System and Various Compensation Methods, Result: Precise Customer Feedbacks Loyalty Programs, Powerful Marketing Campaigns Bring More Revenue and Improve Restaurant Performance, and a Performance/Feedback Loop System that includes Bloggers, Restaurant Fan Club, Digitalized Features, Powerful Telecommunication Technology. The system will offer complete business link management and listing service.

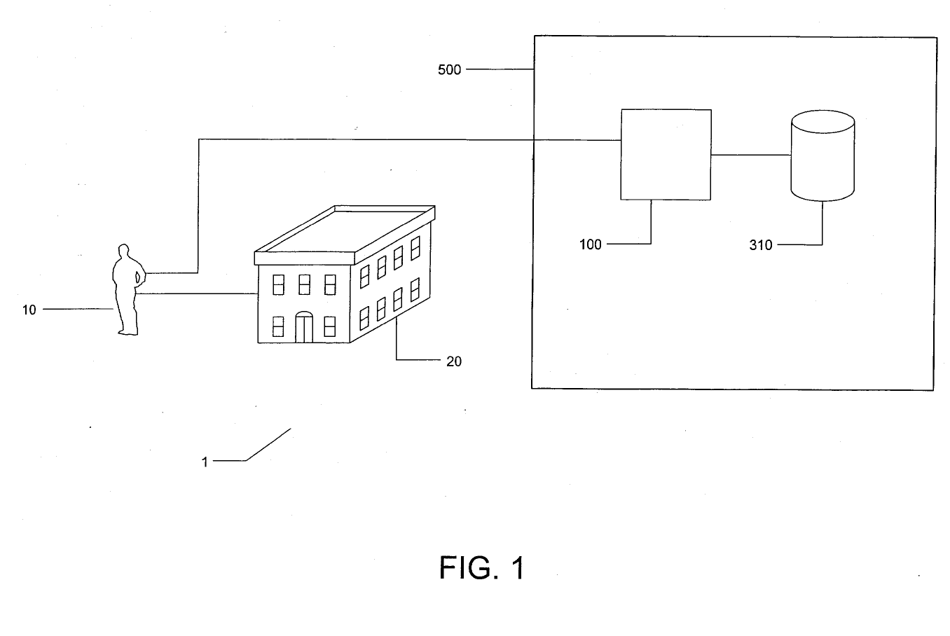

FIG. 1 illustrates a functional diagram of how a User 10 accesses the system 1 from a computer 25 connected to the Internet 500. The computer 25 can be connected directly through a communication means such as a local Internet Service Provider, often referred to as ISPs, or through an on-line service provider like CompuServe, Prodigy, American Online, etc. The system 1 will enable an Auto Sign-on (cache) feature for the Users 10.

The Users 10 contact the Internet 500 using an informational processing system capable of running an HTML compliant Web browser such as Microsoft's Internet Explorer, Netscape Navigator, Lynx, or Mosaic. A typical system that is used is a personal computer with an operating system such as a Windows variant or Linux or Mac OS, running a Web browser. The exact hardware configuration of computer used by the User 10, the brand of operating system, or the brand of Web browser configuration is unimportant to understand this present invention. Those skilled in the art can conclude that any HTML (Hyper Text Markup Language) compatible Web browser is within the true spirit of this invention and the scope of the claims.

The system 1 will have its own impression sound to create a unique branding of the site. They system's website 100 will have a site policy statement that governs the rules of the site. The system 1 will have a website tutorial and guide to assist Users 10 in using that website 100 and system 1. The system 1 will have an animated Flash logo of the website 100.

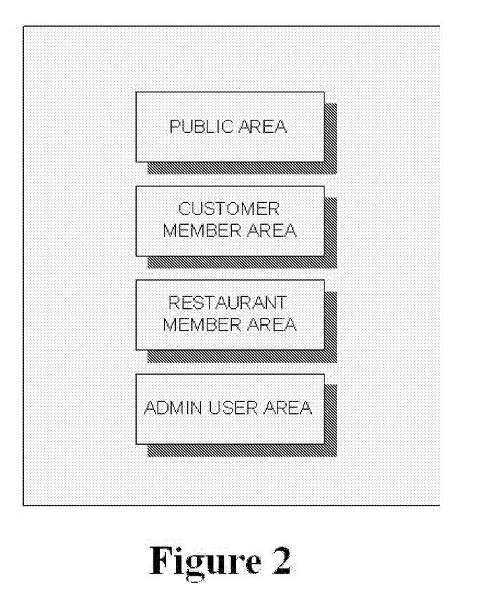

For the purpose of detailing the functionalities, the entire system 1 has been divided into four areas, each area being accessible to a particular user group, as shown in FIG. 2. These areas are the Public Area, Customer User Area, Restaurant User Area and the Admin User Area.

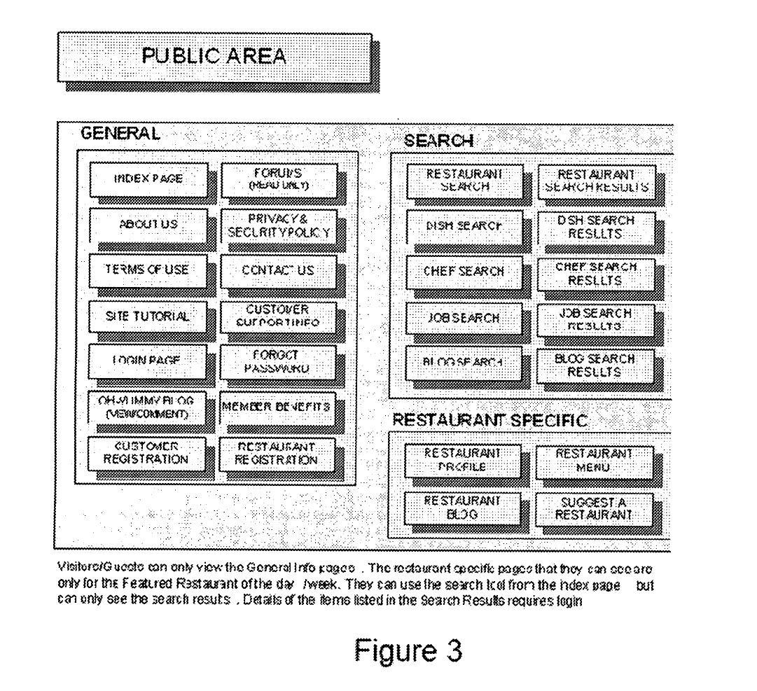

As shown in FIG. 3, the Public Area contains the functionalities which are accessible by all users, logged-in to the system or not. This will allow certain features of the site to be viewed for the benefit of guests/visitors to the site.

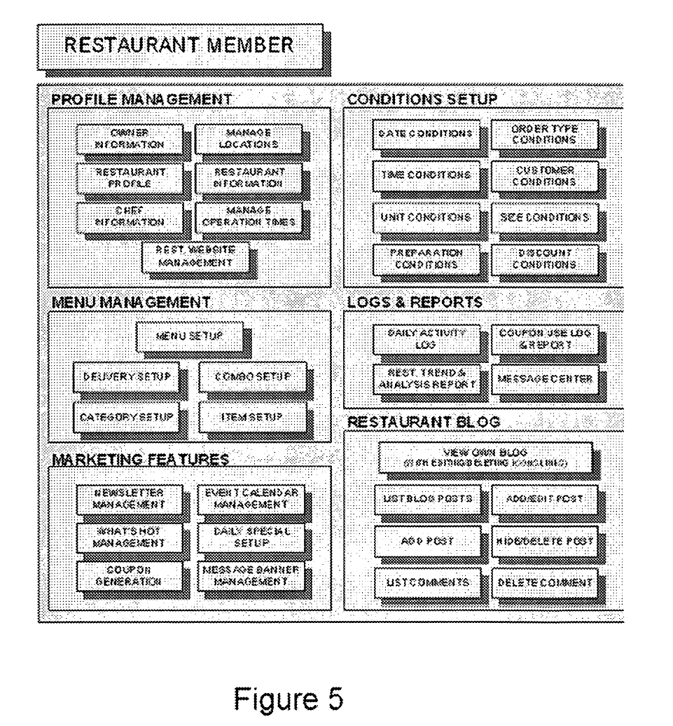

As shown in FIG. 5, the Restaurant Member area contains the functionalities accessible exclusively by a logged-in Restaurant User.

Customer User Area as shown in FIG. 5 contains the functionalities accessible exclusively by a logged-in Customer User.

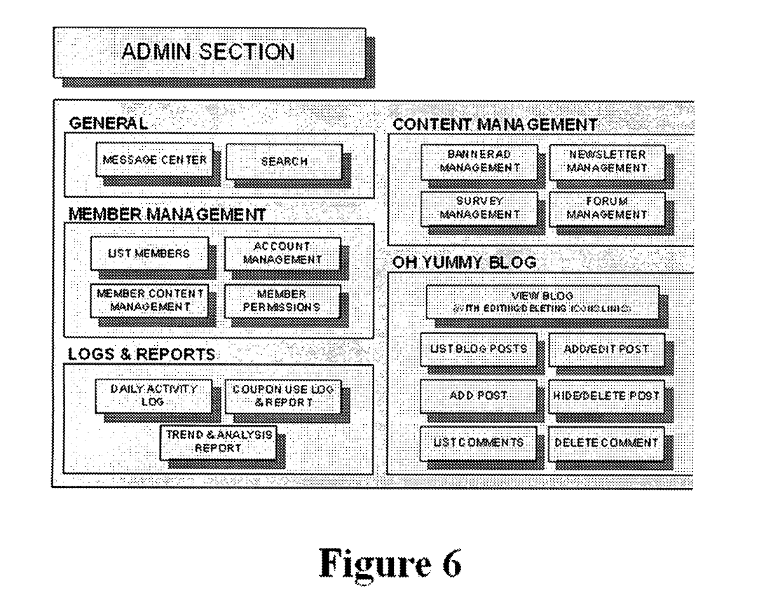

The Admin area is shown in FIG. 6. This section contains the functionalities accessible exclusively by the Site Administrator.

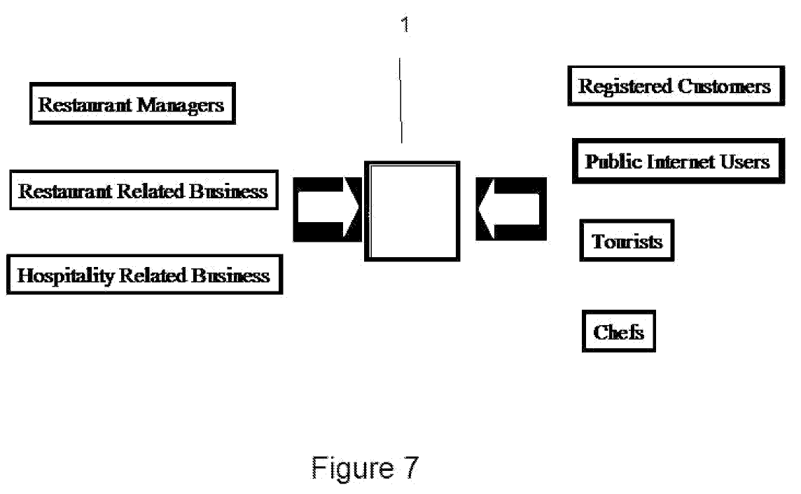

FIG. 7 displays some of the website concepts and diagrams. The various people who use the system as shown in the Business Network Market Place Diagram are Restaurant Managers, Restaurant Related Businesses, Hospitality Related Businesses, Registered Customers, Public Internet Users, Tourists, and Chefs.

The system 1 will allow Customers to perform Data Mining, Community Interactions, look into Social Opportunity Centre, review Restaurant News Portals, access to an Order/Reservation Interface, use a Restaurant Job Search Engine, to check Event and News Calendar, and to use a Coupon Collector. The system 1 brings Customers Convenience, Information, Interactions to Restaurants and Society Events, increased efficiency, user functions as well as entertainment and health benefits.

From a Customer's Point of View, the system 1 brings Entertainment (like Games and Cuisine Map), Management of Activity History, Event Calendar & Daily Planner, Social Interaction with Communities, TableMate Program, and Restaurant Fan Groups. Data-Mining capabilities such as an Extensive Information Search, cuisines and recipes, E-Commerce Shopping Convenience with an On-line Seat Reservation and Order System, a Reward System with Point Collection/Redemption and Coupon Collection, Personal Satisfactions with VIP Treatment, Restaurant Interactions, Customer Support, the Customization of Space and Services such as Dining Habit Analysis, Precise and Restaurant Suggestions, Public Relation such as Discussion Forum, My Restaurant Blog, and a Reminding Service with Multiple Layers of noticing and reminder service for events and Special Days.

The system 1 will have a Tool Bar for the Customers that will display, What's Hot, Top Restaurant Blogs, Top My Restaurant Blogs, Online Reservation, Online Order short cuts, Coupon Collectors, and News and Promotions. The most popular Blogs will be managed by and arranged by the system 1 itself without input for the system administrator. The system 1 in the preferred embodiment will also list and arrange the most popular restaurants and dishes for the Customers.

The system 1 will have the distance from the customer's location to the restaurant if the Customer logs on to the system 1 and browses restaurant profile pages. Every page will indicate the distance. It will also provide a draft city map so that the Customer can see the distance.

The Customers Restaurants will have an option of a “bargain, or name their price” for dish or menu items. The system 1 will have “suggestion questions” as pop-up boxes during the ordering process.

The system 1 will have a feature of “My Old Goodies”—which is a shortcut to make a reservation at their old restaurant, same (or similar) seats and food. A customer can also select seats upon reservation and will be able to view the real view of the restaurant by “walking into” it and pick the seats. Customers will be able to choose a flexible payment plan (installments, like mortgage or loan) in order to dine in a luxurious restaurants.

The menu or order process interface will allow the Customers to select food material type such as “beef”, “pork”, “seafood” or “chicken” and the menu will be rearranged as the start, to shorten the order process or time.

The system 1 will allow the Restaurant choose a time (before, present or at the end of the ordering process) to ask and suggest the ordering customer (while they order food or at the processing pages) what else to order, or suggestions for other meal, add more meal or pay extra to get extra. The Restaurant ill be able to edit the questions to ask and suggest food based on the: definition of the occasions (scenario), correlated events, or ordered meal. This will encourage shopping more, improve the shopping experience, get greater enjoyments and etc; The Restaurant can also suggest the “Daily Special” to the customers don't know what to order or don't know what's good in the restaurant.

The true experience is like, when you are in McDonalds, the clerk sometimes ask you “Sir, would you like to add 49 cents to supersize your meal?”. If you answer “Yes”, the meal will be replaced as a larger fries and drink and your shopping cost will be increased by 49 cents.

The system 1 will provide the Customers with real time reservation and order system where the Restaurant will receive the order in real time. This can be done and confirmed on-line or through telephony or any other such communication means.

The system 1 will provide a cross road restaurant search which will allow the Customer to find Restaurants at a particular location or given route. The system 1 will also have an “Attraction” dropdown box to display the surrounding restaurants and attractions for the customer.

The system 1 will provide to Restaurants a Website Content Management Console, a Marketing Tool/Market Place, a Restaurant Operation Quality Control Console, a Customer Interaction/Support Interface, a Food/Dining Knowledge Library and a 24 Hours Virtual Store. The system 1 brings to Restaurants a Management of Menus/Restaurant Operations, Sales Leads, a Customer Support and Feedback Management function, a Customer Interactions and Loyalty forum, Quality/Service Control and Management, Trend and Analysis Based on Performance and the Power of Targeted Internet Marketing.

From a Restaurant Owners' Point of View, the System 1 will provide Inventory & Material Preparation (Order System); Marketing Opportunity with Customized E-mail Direct Marketing, Coupon Generation/Delivery, On-line Restaurant Flyer Generation, Fan Group Forming, Auctions; Social Interaction with Periodic Social Gatherings, a Restaurant Alliance, On-line Communities, Restaurant Blog, and Restaurant held activities; Customer Support (Direct Interaction, Feedback System, Point reimbursement system, etc); Loyalty Program (Point System, Fan Club Forming, My Favorite, Restaurant List, Direct E-mail Marketing, Direct Interactive Channel to Customers; Sales Lead Generation with an Accept On-line Order, Reservation and Phone based recommendation services; Management tools with an Order Trend Analysis, Customer Management, Job Posting/Resume Collection, Message Console, Operation Days/Hours; Menu Management with a Menu Generation Engine, Coupon Generation Engine and various Discount options; Public Relation (Web Presence, Restaurant Blog, Chef Blogs, Message Delivery); and Consultation with Restaurant Operation Specialist Monitoring the Performance. The Restaurants can choose their own themes, colors and styles on their pages and links.

The system 1 will have a main webpage, as shown in FIG. 3. From this main webpage users can access different parts of the system with some of these parts having their own webpages. The system 1 parts include Games such as City-wide Monopoly combined with Restaurant marketing, Online games that will link to the point system or incentives; Cooking Games, Potato Throwing, Puzzles, Weekly Questions; Online Interactive Cuisine Maps with Printable City Cuisine Map integrated with GPS; system Point Accumulations and Redemptions where the system collect Points while Shop at Sponsored Restaurants and Redeem Points at any Participating Restaurants with a Point Exchange System; Seek and Hide where a user will Look for keywords on the website to win a coupon or gift, a Critical Timing Order Lucky User with Special Rewards to a customer who reserves or order at a specific time or date; a Restaurant Shopping Spree which is Similar to Supermarket Shopping Spree, but for online shoppers; a Free Sample Feast where VIP members can enjoy a Free Sample Feast or go to their favorite restaurant for free once a year; a system Invitation Card which saves time for members who make the reservation or orders, this gives restaurant space to market their business; Company Held Activities like Year Round Restaurant Promotion Regional-wise and Cuisine-wise, Such as “Taste on Danforth”; Exchange discount offer with other travel & hospitality business; and a system Food Critics Ambassador and Secret Jury System.

The system 1 will provide a Restaurant End with Restaurant Initiated Auction Sales where Restaurants can launch auctions on their selected items on the menus; Restaurant Generated Coupon/Flyer/Newsletter Deliveries; Restaurant Users collect customer information and form Fan Group for target marketing; featured activities such as music, romantic gathering, social functions, speeches, chef cooking demonstration; a Restaurant BLOG, a Chef's Blog which are an interactive method to attract customers by introducing more restaurant information and events; a website real time broadcast (Webcast) which a Restaurant can launch or turn on the real time restaurant cooking show or real ambience sound to attract customers; Powerful and multipurpose Discount options where a Restaurant can launch something like “2 Dollars on Tuesday for 2 pieces chickens”; Puzzle Collecting where Customers collect puzzle pieces to redeem a big price; a system Passport where Customers collect stamps on a system Passport to redeem gift or price; a Suggestive Dish where Customers can request the dishes they wish to eat, restaurant names the price and time of dining.

The system 1 provides a direct link to the restaurant's seating map as well as a virtual tour of the restaurant. The system 1 will provide a visual appeasing restaurant seating plan and map as well as the ability for the Restaurant to have a real-time webcam feature and interface.

The system 1 provides a photo editing tool for the Restaurants to upload pictures and films as well as a tool to assist in the uploading of flash files. The system 1 will provide Restaurants with a file management tool and interface for use with the system 1 including a film and movie display interface and editor. The system 1 will have a virtual tour management tool and display area for the Restaurants to use.

The system 1 collects a sample (general) menu (and items) for each cuisine. Restaurant members can select their cuisine type and download the menu and items and make changes, to make it their own seed menu. The Menu will display a showcase (like online photo album) with chef's cross reference and suggestions.

The Restaurants can use their seed menu to create menus such as “Dine-in, Delivery, Catering, Take-out” menus and message managements will be like the Outlook system. The Restaurants can import “Contacts” from various email programs restaurant and can edit, apply conditions, make combos, make changes, manage customers from a tree structure interface similar to the “Folder List” section in Outlook where you can see the types of information you want manage.

The system 1 will offer Website Based Website New Marketing Concept Structure where the system 1 will offer Impression Wallpaper and Mouse Cursor where a Customer can download the wallpaper and the mouse cursor display sporadic discount options or company activities; Company Held Potluck where the system 1 will hold community (discussion group based) events and potlucks to enhance interaction between members; it will offer a My Restaurant Blog where all the customers can be a food critic; the system 1 would include a My Favorite Restaurant List where Users collect their favorite restaurants' information and events; a Coupon Collection Box which would allow Customer not to miss any desired discount options, further connects restaurants and customers; a TableMate Radar Program which is an alternative way of meeting people either in-town or out-of-town, gather people with common interests; and an artificial Intelligence (AI) based Restaurant Suggestion tool and interface in which the System 1 suggests a restaurant based on customer's dining history and preference, price and health condition.

The system 1 will have a calorie calculator and store desired health conditions on the system for use with the interface and at checkout.

The system 1 will have a website Based Loyalty Program for the restaurants including a Restaurant Customer Contact List (group) where the Restaurants can form a contact list group and launch a marketing campaign to these customers; a Newsletter Delivery System where the Restaurant can publish a newsletter and deliver it to the targeted group, contact list or fan group; a Restaurant Blog to publish more event news and information to the public and encourage participation of the activities; a customer “My Favorite Restaurant List” where customers stick to their favorite restaurants; a Customer Feedback & Greeting System; a Customer Direct Channel to interact with restaurants; a Discount Price for Special Group where Restaurant owners can show their appreciation of their customers by giving discount offers or event admissions; and a Customer Appreciation Day which gives an opportunity for Restaurant to appreciate their customers.

The system 1 will be Website Based Website Loyalty Program for the system 1 to the customers which includes a broad and extensive Database and Restaurant Information in which Customers can search an extensive database 310 on restaurants and menus; a Customization of Interfaces where the System 1 suggests restaurants and dishes based on customer's profile, dining habit and preferences; a Useful BLOG with a section called My Restaurant & My Kitchen where Customers leave notes and writes food critics and attracts public to browse articles and encourage shopping; system points and Exchangeable Points; where Customers accumulate system points and redeem services at the participating restaurants; a system Secret Food Critics Ambassadors where the voted active participants will be elected as the agents to taste food and leave feedback on the system's website; a TableMate Radar Program which gives customers chances to meet each other; a Discussion Forum and Communities which gives customers chances to participate in discussion and cross reference of restaurants; and member appreciation activities such as a User Appreciation Day which would be an annual Gala gives customers a chance to dress up and go to the company held festival for free and enjoy food.

The system 1 will have a Website Based Website Loyalty Program for the Restaurants to the system 1 consisting of a Restaurant Profile and Menu Database 320; Customer Support which will handle disputes and solve website problems and menu setup procedures; a Restaurant Operation Performance Report which will accumulate customer's feedbacks and comments with the system 1 generating a report and possibly dispatch consultant to solve problems; a Message Management Console which gives the Restaurant owners direct access to their customers, to handle disputes, compliments and feedbacks; a Customer Contact List and Restaurant Fan Group Generation which are two features that will be very useful to launch marketing campaigns and keep loyal customers; a Restaurant Blog & Chef Blogs; a system Restaurant Alliance which is a restaurant league to support restaurant members to fully utilize the website and reveal the power of the website; and a Regular online Restaurant Newsletter and Restaurant Operation Guide.

In the preferred embodiment, the system 1 will have a number of different webpages 210 such as: System Home Page; Company (Diner Tech Corporation) and Service Related Pages; Company Introduction Pages; User Interactive/Information Request Page; Customer & Technical Support Pages; Miscellaneous Management or Records and Log Pages; About Us Page; Contact Us Page; Service & Tutorial Page; Support Page; Restaurant Related Pages; Restaurant Profile Pages; Restaurant Webpage Management Pages; Restaurant Operation Management & Statistic Pages; Restaurant-Customer Relation Pages (Message Management Panel); Restaurant Marketing Pages; Restaurant Blog; Restaurant Operation/Website Usage Logs & Reports; Restaurant Description Page; Restaurant Photo Page; Map & Driving Direction Page; Restaurant Store Hours/Operation Dates Page; Restaurant Menu & Order Pages (Table & Detail Modes); Customer In-House Order Process Pages; System Restaurant Reservation & Order Report Pages; Customer Delivery Process Page; E-Invite Card Set up Page; Customer Take-Out Order Process Page; Restaurant Famous Dishes Page; Restaurant Daily Specials Page; Restaurant Coupon Page; Restaurant Reservation Page; Restaurant Credit & Awards Page; Restaurant Customer Feedbacks Page; Restaurant Payment Option Page; Restaurant Chef Page; Restaurant Event Calendar Page; Restaurant Newsletter and Contest Page; Restaurant Contact Us Page; Restaurant Job Page; Restaurant Owner Logged On Page (RM Administrative Page); Restaurant Owner Profile Page; Restaurant Basic Profile Page; Restaurant Information Page; Restaurant Store Hours/Dates Management Page; Restaurant Pictures/Video/Audio Upload Page; Restaurant Chef Management Page; Restaurant Menu Management Page; Restaurant Meal Set/Combo Set up Page; Restaurant Delivery Management Page; Restaurant Order & Reservation Log Page; Restaurant Mass Email Delivery Page; Restaurant Event Setup and Management Page; Restaurant Edit & Modify Daily Special Page; Restaurant Running Message Banner Setup Page; Restaurant Message Center; Restaurant Coupon Generation Page; Restaurant Coupon Log & Report Page; Restaurant Trend & Analysis Pages; Restaurant Web Pages and Features Management Page; Restaurant Menu Set up Pages; Restaurant Menu Management Pages; Restaurant Conditions Set up Pages; Public Participation Pages; Game Page; Survey Page; Customer Suggestions & Referral Pages; Public Discussion & Management Pages; Survey Entry Page; Survey Result Page; System Discussion Forum Home Page; System Discussion Forum Article Page; System Discussion Forum Board Management Page; System Discussion Forum Email to Friends Page; Introduce This Restaurant to Your Friends Page; Suggest a Dish Page; Suggest a Restaurant Page; Suggest This Site to Your Friend Page; Registered Customer User Pages; Customer Information & Preference Pages; Website Usage & History Pages and Reports; C2C, C2B Message Management Pages; Restaurant Information & Promotion Collection Pages; System Registered User Participation Pages; Customer Showcase Pages; Website Driven Customized Logs and Pages; User User Registration Page; User Promotion News/Coupon Collection Page; User Event Calendar and Planner Page; User Message Management Pages; User Feedback Form; User Order/Reservation/Delivery History Page; User Payment Methods Information Page; User My Favorite Restaurant Page; User Watch List Page; User TableMate Radar Management Pages; User “My Kitchen” & “My Restaurant” Blogs; Marketing & Advertisement Pages; Featured Cuisines & Dishes Articles; Website Wide Advertisement Related Links and Pages; Related or Suggested Business Links; Joint Program or Strategic Alliance Pages; Feature Restaurant of The Day Article Pages; Feature Food of The Week Pages; Dining News Pages; Business Links; Advertisement Banners; System Feature Pages; Various Types of Search Pages; System Point Redemption System; Order & Checkout Transaction Pages; User Registration Pages; Restaurant Search Page; Restaurant Search Result Page; Most Popular Restaurant Page; New Restaurants Page; Most Popular Dishes Page; Dish Search Result Page; Restaurant Chef Search Result Page; Restaurant Job Search Result Page; Top Restaurant Blogs Page; Supporting & Response Pages; Registration Pages; Logging Related Pages; Responsive Pages; Forget Username & Password Page; Responsive Pages; Miscellaneous Pages; Terms and Conditions; System Impression Pages; and System Entry Page.

The system 1 will be able to interact with customers via a number of different languages such as English, Spanish, Chinese, German, English, Russian, Chinese (traditional, simplified), Greek, Italian, French and any other language needed for a particular location or market. In the preferred embodiment, the system 1 will have flags which correlate to several languages such as: France, Italy, Thailand, Germany, Malaysia, Vietnam, Saudi Arabia, China, Taiwan, Japan, Korea, Spain, Israel, and Great Britain.

The system's home page will have testimonial sections and links to restaurant profile pages as well as flexible article display space.

In the preferred embodiment, instead of Excellent, Good, Fair to Poor, the system 1 will have pictures of “Two Thumbs up” “Plain Face”, and “Disappointing Face”. In the background, each picture still carry's the meaning of the four situations, “One Thumb up”, “One side way thumb”, and “One thumb down”. Another option is to use “Brilliant and satisfying Smile”, “Joyful smile”, Plain Face, and “Disappointing Face”.

The system 1 will have a system ranking for a Famous Dishes webpage.

The system 1 will have a Restaurant Matching Index Number for each restaurant. This number will be displayed on the restaurant profile pages while Customer logs on to the page. The higher score of the Restaurant Matching Index Number, the more likely a customer will dine in this restaurant. The system 1 uses point system and the score is based on the following factors and records.

a. Customer's Preference Cuisine Type, if customer likes this type of cuisine, the point will be added.

b. Customer's Favorite Dishes, if this restaurant provides such dish, the point will be added.

c. Driving Distance, if the restaurant is located within the desired driving distance by Customer, the point will be added.

d. Restaurant Performance with Customer emphasis on certain types of restaurant performance such as quality, appearance, ambience, service, speed, cleanliness and Value For Money, and if this restaurant has good performance on this group, the point will be added.

e. Customer's personal dining experience, if Customer gives good feedback to this restaurant, the point will be added.

f. My Favorite Restaurant Score, if Customer adds this restaurant to their My Favorite Restaurant List, the score will be listed.

g. Shopping Times, if Customer shops or participates in events at this restaurant many times, the score will be added.

h. My Restaurant Blog (if Customer writes about this restaurant, the score should be added or deducted based on the feedbacks or comments.

The maximum score should not exceed 100 points

The system's 1 Blogs such as My Restaurant and Restaurant Blogs should have space to let browsers comment to them.

When a customer logs on to the site, the screen and advertising that they will see on the website will be the cuisine types they tend to prefer. This is very novel to the industry. The system 1 is an intelligent system that will learn what a customer likes and act accordingly to those likes.

The system 1 will have GPS integration. The system 1 will be able to connect to customer's GPS no matter where they are, they will be led to the desired or preferred restaurant based on their request or preference. The system will have a City Cuisine Map. The system 1 will also provide driving directions for the Restaurant Members for delivering food to Customers.

The System 1 can be customized for people who want to reach their goals, such as losing weight, kosher dining, low carb, low fat or food allergies. The website 100 will tailor and display the available restaurants for their request and arrange the menu in combined with doctor's suggestions or nutrients' suggestions and analysis to provide the best suggestion to the customer. The Customer will be asked to enter the goals they want to reach at the user profile. The system will automatically match the right food or restaurant to them.

In preferred embodiment, once customers finish their meal, they will receive the feedback request form and all of the ordered items will automatically be listed in the “Request to write article (comments)” Blog as items. This will also allow a Customer to write articles regarding a restaurant and its dishes. The Customer will also be able to on the System 1 to read the articles of the items (or restaurant) by clicking “Read articles in Blogs” link (or button) next to a dish name or a link in the restaurant related page (at the bottom)—read articles of this website in the Blog once the mouse is moved on top of the above mentioned link, it will pop-up the top 5 all of the pictures and print out have company logo in order to prevent piracy.

The system 1 will have a website admin instant messenger system (like MSN and Yahoo Messenger) in order to transmit instant order request and confirm the orders and for users, receiving new dining news, suggestions, recipes, order/reservation shortcuts. The system 1 will have an “Add Suggestions” feature to the website so that Users and Restaurants and provide comments on how to improve the system.

For better customer service, the System 1 will have an online chatroom type interface for customer support for both the Customer and the Restaurants.

The system 1 will offer gift certificates and gift cards that can be used at any Restaurant on the system 1. The system 1 will give Restaurants a postcard feature where the Restaurants can send out postcards to the Customers with photos of their dishes. The system 1 will have a display area for a Newsletter for the restaurants in the Restaurant Profile Page area.

In the preferred embodiment, the program and its routines will be written in C++ language, however, the program can be written in any standard programming language. RFID technology will be implemented for better tracking of dishes, inventories, customers, loyalty card, etc. The system 1 will provide friendly printing for all restaurant profile pages. The system 1 will allow Restaurants to implement Fax notifications to customers. The system 1 will allow the Customers and Restaurant to add a link to their websites to the system.

The system 1 will allow Restaurants to select customers based on a given set of conditions. The website 100 will also have a universal site search function.

The system 1 provides a Process of Restaurant Operation (all-in-one and quality assurance control loop system) with Interfaces and expression of restaurant information on its website with marketing applications for restaurants such as Games, Auctions, Message Banners, Job Portals, Event Boards, Broadcasting systems, Fan Group Forming, chat room, Instant Messenger, and E-Invite. The system 1 has its own marketing interface and approach, Restaurant BLOG, My Kitchen/My Kitchen BLOGs.

The system 1 has cross references and smart suggestions of restaurants with a useful calendar tool, event planner, and coupon collections. The system 1 has customer/restaurant interactive communication channels by E-mail, chat room, MMS, SMS, etc; with telecommunication technology integration which is the integration of order/reservation and management directory/interface giving various methods to group and invite customers to dine at the participating restaurants. The telephony interactive system (Interactive Voice Responsive) and FAX and possibly other devices will be in place at the restaurant to enhance the promptness and precision of ordering/reservation for the system. The telephone interface version of the system 1 will be designed so that restaurant owners can operate the website content and get orders through phone and customers can use phone based interface to manage their information such as ordering and reservation. The Cell phone, PDA and various mobile devices will interface with the system 1 and its website.

The system 1 provides for advanced menu and discount management interface with Old Goodies, consumer diet analysis and smart suggestions.

### Alternative Embodiments

In an alternative embodiment, the System 1 could also be used in a Wireless cell phone environment.

In another embodiment, the scope of the system 1 and linking of databases could be broadened to various industry such as Taxi hiring service, Hotel booking service, Airline ticket booking service, Movie/Event ticket booking service, Read food ordering service (such as supermarket), On Flight Food Order service, Grocery Shopping service as well as others.

### Advantages

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A restaurant system comprising;
having a customer and restaurant interactive communication channels using telecommunication technology integration.

2. A restaurant system according to claim 1 where said system is downed and installed on a user's computer.

3. A restaurant system according to claim 1 where said system has information on a plurality of restaurants and where said restaurants are based on a GPS system.

4. A restaurant system according to claim 3 where a customer can make a reservation at said restaurants.

5. A restaurant system according to claim 4 where a customer can choose their seating based on a seating map at said restaurants.

6. A restaurant system according to claim 4 where a customer can take a virtual tour of said restaurants.

7. A restaurant system according to claim 1 where a customer can rate a restaurant.

8. A restaurant system according to claim 3 where said restaurant can list their menus.

9. A restaurant system according to claim 3 where said restaurant can promote a particular dish.

10. A restaurant system according to claim 3 where said restaurant can offer promotions.

11. A restaurant system according to claim 3 where said restaurant can offer information on its employees.

12. A restaurant system according to claim 1 where said customer can search for restaurants based on location.

13. A restaurant system according to claim 1 where said customer can search for restaurants based on dietary needs.

14. A restaurant system according to claim 1 where a customer can write BLOGS.

15. A restaurant system according to claim 1 where a restaurant can write a news letter.

16. A restaurant system according to claim 1 where said system will provide business data for restaurants.

17. A restaurant system according to claim 1 where said system will provide file management tools for users

18. A restaurant system according to claim 1 where said system will provide trend data for restaurants.

19. A restaurant system according to claim 1 where said system will provide marketing tools for restaurants.

20. A restaurant system comprising;
having a customer and restaurant interactive communication channels using telecommunication technology integration, where said system has information on a plurality of restaurants, where a customer can make a reservation at said restaurants, where a customer can choose their seating based on a seating map at said restaurants and can take a virtual tour of said restaurants, where a customer can rate a restaurant, in which a restaurant can list their menus, promote a particular dish and offer promotions, and in which said customer can search for restaurants based on location and on dietary needs.
